(19) United States
(12) Patent Application Publication
(10) Pub. No.: US 2016/0232133 A1
(43) Pub. Date: Aug. 11, 2016

(54) METHOD AND DEVICE FOR REARRANGING PARAGRAPHS OF WEBPAGE PICTURE CONTENT

(71) Applicant: UC MOBILE LIMITED, Beijing (CN)

(72) Inventor: JIE LIANG, Beijing (CN)

(21) Appl. No.: 15/132,056

(22) Filed: Apr. 18, 2016

Related U.S. Application Data
(63) Continuation of application No. 13/880,976, filed on May 31, 2013.
Application No. 13/880,976 is a continuation of application No. 13/880,977, filed on May 31, 2013.

(30) Foreign Application Priority Data
Oct. 21, 2010 (CN) 2010-10521691.1
Oct. 21, 2010 (CN) 2010-10521693.0

(51) Int. Cl. G06F 17/21; G06T 7/00; G09G 5/00; G06F 17/22; G06F 17/24

(52) U.S. Cl. CPC G06F 17/212; G06F 17/2247; G06F 17/24; G09G 5/005; G06T 7/0081; G09G 2340/145

(57) ABSTRACT

The present invention provides a method for recomposing individual characters obtained by segmenting webpage image, including determining whether the line of words is the start line of a new paragraph on the webpage image based on the blank space at the beginning of the line. When a line of words is determined as the start line of a new paragraph, it is set as the start line of the new paragraph being recomposed and the original blank space at the beginning of line is retained, and all segmented individual characters are recomposed according to the screen size of the mobile terminal. When the line of words is determined as not the start line of a new paragraph, all segmented individual characters are recomposed so as to be immediately after the ending character of the recomposed previous line of words according to the screen size of the mobile terminal.

### CROSS-REFERENCES TO RELATED APPLICATIONS

This application is a continuation application of U.S. patent application Ser. No. 13/880,976, filed on May 31, 2013, which is a U.S. national stage application of International Patent Application PCT/CN2011/080969, filed on Oct. 19, 2011, which claims priority of Chinese Patent Application No. 201010521693.0, filed on Oct. 21, 2010, and a continuation application of U.S. patent application Ser. No. 13/880,977, filed on May 31, 2013, which is a U.S. national stage application of International Patent Application PCT/CN2011/080968, filed on Oct. 19, 2011, which claims priority of Chinese Patent Application No. 201010521691.1, filed on Oct. 21, 2010, the entire contents of all of which are incorporated herein by reference.

### FIELD OF THE DISCLOSURE

The present invention relates to the field of webpage browsing, and more particularly, to a method and device for recomposing contents of webpage pictures by utilizing segmented individual characters.

### BACKGROUND

With the development of communication techniques, it is becoming a trend to log on novel websites to browse novel contents by mobile terminals. In order to protect the copyright of novel contents published on novel websites, picture format is adopted to show novel contents, especially some VIP chapters of a novel, by many novel websites, thereby preventing these contents to be duplicated by readers.

The disclosed method and system are directed to solve one or more problems set forth above and other problems.

### BRIEF SUMMARY OF THE DISCLOSURE

### Technical Problem

As the contents of novel websites are usually displayed by personal computers (PCs), the picture formats of novels showed on these novel websites are generally designed for display screens of PCs. While users log on novel websites to browse web pages through mobile terminals, novels in the picture formats cannot be displayed on the small screens of mobile terminals as conveniently as on PCs, because images in picture formats usually have large size. In this case, if the novel images are zoomed out to fit the sizes of screens of mobile terminals, words are zoomed out to be too small to be read. If images are showed in original picture formats, users need to move the windows left and right repeatedly when reading such which is very inconvenient.

With respect to the abovementioned problem, contents of web images are required to be adapted to the sizes of display screens of mobile terminals, such as recomposing contents of web images, while users browse novel contents on novel websites through mobile terminals.

As novel contents are composed in character as the basic unit, the web images are required to be segmented to obtain individual characters before the contents of webpage images being composed.

After the characters in the web pages images are segmented as described above, the segmented individual characters are required to be recomposed so as to be adapted to be displayed on screens of mobile terminals according to the screen size of the mobile terminals.

### Technical Solution

In consideration of the above discussion, the present invention provides a character segmenting method and apparatus for web page pictures, wherein web page pictures containing fiction contexts can be segmented into individual characters, and the obtained individual characters can be rearranged to the screen size of a mobile terminal so that the fiction contexts can be appropriately displayed on the screen of the mobile terminal.

According to one aspect of the present invention, there is provided a character segmenting method for web page pictures, comprising scanning row by row the pixels of an obtained web page picture and demarcating in units of rows the web page picture into first blank regions each consisting of continuous blank pixel rows and first content regions each consisting of continuous content pixel rows; segmenting the demarcated first content regions from the obtained web page picture; scanning column by column the pixels of each of the segmented first content regions, and demarcating in units of columns each of the segmented first content regions into second blank regions each consisting of continuous blank pixel columns and second content regions each consisting of continuous content pixel columns; and segmenting the second content regions and the second blank regions according to the pixel coordinates of the second blank regions and taking the segmented second content regions as individual characters in the first content regions.

Furthermore, in one or more embodiments, the step of segmenting the demarcated first content regions from the obtained web page picture may further comprise: determining whether the first content regions are fiction picture or not according to the heights of the demarcated first content regions and the height characteristic of character rows in fiction pictures; and when a first content region is determined to be a fiction picture, segmenting the first content region from the obtained web page picture with the center lines of two adjacent blank regions thereof as boundaries.

Furthermore, in one or more embodiments, the step of determining whether the first content regions are fiction pictures or not may comprise: calculating the mean height of the first content regions; and when the calculated mean height of the first content regions falls within a first threshold range, determining that the first content regions are a fiction picture.

Furthermore, in one or more embodiment, the step of determining whether the first content regions are fiction pictures or not may further comprise: calculating the height standard deviation of the first content regions; and when the mean height of the first content regions falls within the first threshold range and the ratio of the height standard deviation to the mean height of the first content regions is less than a second threshold value, determining that the first content regions are a fiction picture.

Furthermore, the step of segmenting the second content regions and the second blank regions according to the pixel coordinates of the second blank regions may further comprise: determining the maximal width of the second content regions according to the pixel coordinates of the demarcated second blank regions; determining the character segmenting points of the second content regions by using the determined maximal width of the second content regions and the endpoint coordinates of the second blank regions; and segmenting the second content regions and the second blank regions by using the determined character segmenting points of the second blank regions so as to take the segmented second content regions as individual characters in the first content regions that are determined as fiction pictures.

Furthermore, while the pixels of an obtained web page picture are scanned row by row or column by column, it is possible to perform a watermark filtering treatment on the web page picture according to the pixel grey values thereof.

According to another aspect of the present invention, there is provided a character segmenting apparatus for web page pictures, comprising a first demarcating unit, configured for scanning row by row the pixels of an obtained web page picture and demarcating in units of rows the web page picture into first blank regions each consisting of continuous blank pixel rows and first content regions each consisting of continuous content pixel rows; a first segmenting unit, configured for segmenting the demarcated first content regions from the obtained web page picture; a second demarcating unit, configured for scanning column by column the pixels of each of the segmented first content regions, and demarcating in units of columns each of the segmented first content regions into second blank regions each consisting of continuous blank pixel columns and second content regions each consisting of continuous content pixel columns; and a second segmenting unit, configured for segmenting the second content regions and the second blank regions according to the pixel coordinates of the second blank regions and taking the segmented second content regions as individual characters in the first content regions.

Furthermore, in one or more embodiments, the first segmenting unit may further comprise: a first judging unit, configured for determining whether the first content regions are fiction picture or not according to the heights of the demarcated first content regions and the height characteristic of character rows in fiction pictures; and a first cutting unit, when a first content region is determined to be a fiction picture, cutting the first content region from the obtained web page picture with the center lines of two adjacent blank regions thereof as boundaries.

Furthermore, in one example, the first segmenting unit may further comprise: a calculating unit, configured for calculating the mean heights of the first content regions, and when the calculated mean height of the first content regions falls within a first threshold range, the first judging unit determines that the first content regions are a fiction picture.

Furthermore, in another example, the calculating unit may further calculate the height standard deviation of the first content regions, and only when the mean height of the first content regions falls within the first threshold range and the ratio of the height standard deviation to the mean height of the first content regions is less than a second threshold value, the first judging unit determines that the first content regions are a fiction picture.

Furthermore, in one or more embodiments, the second segmenting unit may comprise a first determining unit, configured for determining the maximal width of the second content regions according to the pixel coordinates of the demarcated second blank regions; a second determining unit, configured for determining the character segmenting points of the second content regions by using the determined maximal width of the second content regions and the endpoint coordinates of the second blank regions; and a second cutting unit, configured for cutting the second content regions and the second blank regions by using the determined character segmenting points of the second blank regions so as to take the segmented second content regions as individual characters in the first content regions that are determined as fiction pictures.

Furthermore, the character segmenting apparatus may further comprise a watermark filtering unit, while the pixels of an obtained web page picture are scanned row by row or column by column, the water filtering unit is used to perform a watermark filtering treatment on the web page picture according to the pixel grey values thereof.

According to still another aspect of the present invention, there is provided a mobile terminal comprising the above mentioned character segmenting apparatus for web page pictures.

According to yet still another aspect of the present invention, there is provided a server comprising the above mentioned character segmenting apparatus for web page pictures.

In light of the aforementioned, the present invention discloses a method and device for recomposing individual characters segmented based on webpage image, by which the segmented individual characters may be recomposed according to the screen size of the mobile terminal, with the composing styles of the original webpage images being retained to the largest extent, so as to be adapted to be displayed on screens of mobile terminals to enhance the user experience.

In accordance with one aspect of the present invention, a method for recomposing individual characters segmented based on webpage image to be displayed on mobile terminals is provided, the method comprises: when a line of words is determined as the start line of a new paragraph on the webpage image based on the starting blank space at the beginning of the line of words on the webpage image being processed, the line of words is set as the start line of the new paragraph subjected to recomposing, and the original starting blank space is retained, and the line of words is recomposed based on the screen size of the mobile terminal by utilizing all of the individual characters segmented from the line of words; and when the line of words is determined as not the start line of a new paragraph on the webpage images, all of the individual characters segmented from the line of words are recomposed based on the screen size of the mobile terminal so as to be immediately after the ending character of the recomposed previous line.

Furthermore, in one or more embodiments, recomposing, according to the screen size of the mobile terminal, all of the individual characters segmented based on the line of words also comprises: with regard to two characters located at a neighboring positions in the same line after being recomposed, setting the pitch of the two characters in accordance with the relationship of the locations of the two characters on the webpage image; and setting the pitches of the neighboring lines at different pitches according as the neighboring lines having been recomposed locate in the same paragraph or not.

Furthermore, if the two characters locate in the same line and are adjacent to each other on the webpage image, the pitch of the two characters is retained at the original pitch upon being recomposed.

Furthermore, if the two characters locate in different lines on the webpage image, the pitch of the two characters being set at a predetermined pitch upon being recomposed. The predetermined pitch may be, such as, an average pitch.

Furthermore, when all of the individual characters segmented based on the line of words are recomposed according to the screen size of the mobile terminal, with regard to two words located at neighboring positions in the same line of the webpage image, if the two words are not located at neighboring positions in the same line after being recomposed, the former word is determined as the last word of a line and the latter word is determined as the first word of the following line.

Furthermore, the method can be implemented by the browser of the mobile terminal, or implemented at server-side.

In accordance with another aspect of the present invention, a device for recomposing individual characters segmented based on webpage image is provided, the device comprises: a paragraph start line determining unit for determining whether a line of words that is being processed is the start line of a new paragraph on the webpage image based on the blank space at the beginning of the line of words; a recomposing device used for, based on the determining results of the paragraph start line determining unit, determining whether to recompose all of the individual characters segmented based on the line of words to be immediately after the ending character of the recomposed previous line of words according to the screen size of the mobile terminal, wherein, the recomposing unit further comprises a new paragraph processing unit which is used for, when the line of words is determined as the start line of a new paragraph on the webpage image, recomposing this line by setting the line of words as the start line of the new paragraph being recomposed and retaining the original blank space at the beginning of the line.

Furthermore, in one or more embodiments, the recomposing unit may also comprises: a character pitch determining unit used for, with regard to two characters located at neighboring positions in the same line after recomposing, setting the pitch of the two characters after being recomposed in accordance with the relationship of the locations of the two characters on the webpage image; and a neighboring lines pitch determining unit used for setting the pitches of the neighboring lines as different pitches according as the neighboring lines subjected to recomposing locate in the same paragraph or not.

Furthermore, if the two characters locate in the same line and are adjacent to each other on the webpage image, the pitch of the two characters is set as the original pitch by the character pitch determining unit.

Furthermore, the pitch of the two characters is set at a predetermined pitch by the character pitch determining unit, if the two characters locate in different lines on the webpage image.

Furthermore, for two words locate in the same line and are adjacent to each other on the webpage image, if the two words are not located at neighboring locations in the same line, the former word is determined as the last word of a line and the latter word is determined as the first word of the following line.

Furthermore, the device may be installed in the browser of the mobile terminal.

A mobile terminal comprising the aforementioned device is provided in accordance with yet another aspect of the present invention.

A server comprising the aforementioned device is provided in accordance with yet another aspect of the present invention.

### Advantageous Effects

With above described character segmenting method and apparatus, it is possible to segment a web page picture into individual characters, and rearrange fiction contexts to the screen size of a mobile terminal by using the segmented individual characters so as to appropriately display the fiction contexts on the screen of the mobile terminal.

In addition, it is possible to improve the accuracy of demarcating the blank regions and the content regions, and thus improve the accuracy of the character segmenting by performing a watermark filtering treatment on the web page picture.

By utilizing the aforementioned method and device, the segmented individual characters may be recomposed according to the screen size of the mobile terminal, while the composing styles of the webpage images being retained to the largest extent, so as to be adapted to be displayed on screens of mobile terminals to enhance the user experience.

In order to achieve the above and other related objects, one or more aspects of the present invention include those features to be described in detail in the followings and particularly defined in the claims. The following descriptions and accompanying drawings describe in detail certain illustrative aspects of the present invention. However, these aspects only illustrate some of the ways in which the principle of the present invention can be used. In addition, the present invention intends to include all these aspects and their equivalents.

### BRIEF DESCRIPTION OF THE DRAWINGS

The following drawings are merely examples for illustrative purposes according to various disclosed embodiments and are not intended to limit the scope of the present disclosure.

FIG. 1 shows a flow chart of the method for recomposing individual characters segmented based on webpage images to be displayed on mobile terminals according to an embodiment of the present invention;

FIG. 2 shows a schematic block diagram of the recomposing device for recomposing individual characters segmented based on webpage images to be displayed on mobile terminals according to an embodiment of the present invention;

FIG. 3 shows a mobile terminal comprising the recomposing device according to the present invention;

FIG. 4 shows a server comprising the recomposing device according to the present invention;

FIG. 5 is a flow chart showing a character segmenting method for web page pictures according to one embodiment of the present invention;

FIG. 6 is an exemplified flow chart showing the process of segmenting the first content regions of FIG. 5;

FIG. 7 is an exemplified flow chart showing the process of segmenting the second content regions of FIG. 5;

FIG. 8 is a schematic block diagram showing a character segmenting apparatus for web page pictures according to one embodiment of the present invention;

FIG. 9 is a schematic block diagram showing an exemplified structure of the first segmenting unit of FIG. 8;

FIG. 10 is a schematic block diagram showing an exemplified structure of the second segmenting unit of FIG. 8;

FIG. 11 is a schematic block diagram showing a mobile terminal comprising the character segmenting apparatus according to the present invention; and

FIG. 12 is a schematic block diagram showing a server comprising the character segmenting apparatus according to the present invention.

Similar signs throughout all figures indicate similar or corresponding features or functions.

### DETAILED DESCRIPTION

Various specific details are set forth in the following description to comprehensively understand one or more embodiments for sake of illustration. However, it is obvious that these embodiments can be implemented without such specific details. In other examples, known structures and devices are shown by block diagrams for convenience in describing one or more embodiments. And those skilled in the art will readily understand that, the term “character” used throughout this application refers to a basic unit of language when displayed on a computer screen or on a mobile terminal, for example, in Chinese language, “character” may refers to a Chinese character, and in English, it may refer to an English word.

Hereinafter, various embodiments of the present invention will be described in detail with reference to the drawings.

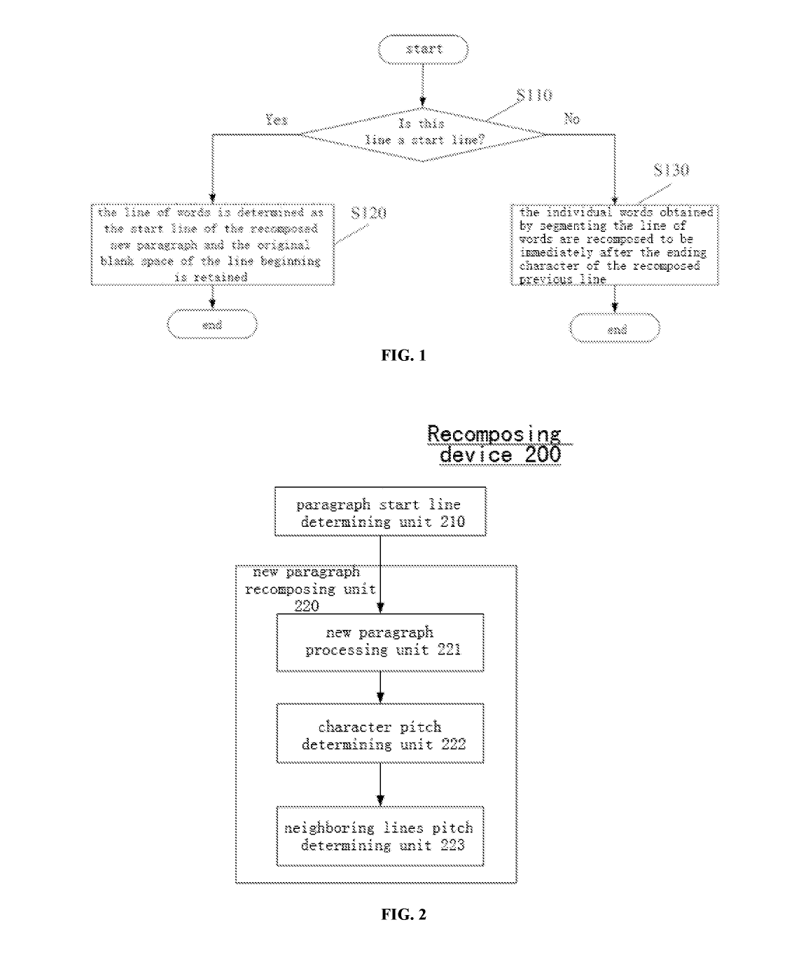

FIG. 1 shows the flow chart of the method for recomposing individual characters obtained by segmenting webpage images and displaying on mobile terminals according to one embodiment of the present invention.

First, in step S110, for a line of words in a webpage image being processed, it is determined whether the line of words is the start line of a new paragraph on the webpage image based on the blank space at the beginning of the line of words, as showed in FIG. 1. For example, an average value of the blank spaces at the beginning of all lines on the webpage image may be calculated firstly. Then, whether the blank space at the beginning of the line of words is larger than the average value is determined. If the blank space at the line beginning of a line of words is greater than the average value, the line of words is considered as the start line of a new paragraph. Otherwise, the line of words is considered as a following line of the original paragraph. Other methods can also be used to determine whether a line of words is the start line of a new paragraph, for example, the users assign a threshold range in advance, and the line of words is determined as the start line of a new paragraph when the size of the blank space at the beginning of the line falls into the threshold range.

When a line of words is determined as the start line of a new paragraph on the webpage image, the procedure processes to step S120. In step S120, the line of words is determined as the start line of the recomposed new paragraph and the original blank space at the beginning of the line is retained in the recomposed paragraph, and then the line of words are recomposed according to the screen size of the mobile terminal with the individual characters segmented based on said line of words.

In step S130, when the line of words is determined as not the start line of a new paragraph on the webpage image, the line of words are recomposed immediately after the ending character of the recomposed previous line of words according to the screen size of the mobile terminal with all of the individual characters segmented based on said line of words.

When recomposing is performed according to the screen size of the mobile terminal with respect to all of the individual characters segmented based on the line of words, the recomposed neighboring characters and neighboring lines are required to set pitches in accordance with the following method.

With regard to two characters located at neighboring positions in a same line after recomposing, the pitch of the two characters after being recomposed is set in accordance with the relationship of the locations of the two characters on the webpage image. In particular, if the two characters locate in the same line and are adjacent to each other on the webpage image, the pitch of the two characters is retained at the original pitch after being recomposed, said original pitch refers to the pitch between the two characters on the webpage image before being segmented. If the two characters locate in different lines on the webpage image, the pitch of the two characters is set at a predetermined pitch. For example, the predetermined pitch may be an average pitch of neighboring characters on the webpage image or an average pitch of recomposed characters. Obviously, the predetermined pitch may be an arbitrary pitch as required by users.

Furthermore, when recomposing is performed according to the screen size of the mobile terminal with respect to all of the individual characters obtained by segmenting the line of words, with regard to two words located at neighboring positions in the same line of the webpage image, if after recomposing the two words are not located neighboring positions in the same line, the former word is determined as the last word of a line and the latter word is determined as the first word of the following line.

Also, when all of the segmented individual characters are recomposed according to the screen size of the mobile terminal, pitches between neighboring lines are also required to be set as different pitches according to whether the neighboring lines subjected to recomposing are located in the same paragraph or not. As an example, if the two neighboring lines subjected to recomposing are located at the same paragraph, the pitch of the two neighboring lines is set as one-sixth of the average line-height. If the two neighboring lines subjected to recomposing are not located at the same paragraph, the pitch of the two neighboring lines is set as half of the average line-height.

It is noted herein that the abovementioned method can be implemented by the browser of a mobile terminal, or implemented at server-side.

When the abovementioned method is implemented by the browser of a mobile terminal, the browser generally has powerful functions. When the abovementioned method is implemented by the server, the URLs required to be browsed are transmitted to the server by the browser client of the mobile terminal and the information of the size of screen (in unit of pixel) of mobile terminal is transmitted to the server, and then the server obtains webpage data from the URL and resolves and recomposes the webpage. After recomposing, recomposed results are transmitted to the browser clients by the server.

The method for recomposing individual characters obtained by segmenting webpage images and displaying them on mobile terminals according to the present invention is described with reference to FIG. 1. The above method for recomposing individual characters obtained by segmenting webpage images and displaying them on mobile terminals in accordance with the present invention may be implemented with software, hardware, or a combination of software and hardware.

FIG. 2 shows a schematic block diagram of the recomposing device 200 for recomposing individual characters obtained by segmenting webpage images for displaying on mobile terminals according to one embodiment of the present invention. The recomposing device 200 comprises a paragraph start line determining unit 210 and a recomposing unit 220 as showed in FIG. 2. The recomposing unit further comprises a new paragraph processing unit 221.

Whether the line of words is a start line of a new paragraph on the webpage image is determined by the paragraph start line determining unit 210 based on the blank space at the beginning of the line of words on the webpage image being processed.

Based on the results determined by the paragraph start line determining unit, the recomposing unit 220 determines whether to recompose all of the individual characters obtained by segmenting the line of words according to the screen size of the mobile terminal so as to be immediately after the ending character of the recomposed previous line of words.

When the line of words is determined as the start line of the new paragraph on the webpage image, the new paragraph processing unit 221 of the recomposing unit 220 sets the line of words as the start line of the new paragraph being recomposed and the original blank space at the beginning of the line is retained there, and all of the individual characters obtained by segmenting the line of words are recomposed according to the screen size of the mobile terminal.

When the line of words is determined as not the start line of a new paragraph on the webpage images, the recomposing unit 220 recomposes the line of words so as to be immediately after the ending character of the recomposed previous line of words.

Furthermore, the recomposing unit 220 may also comprise a character pitch determining unit 222 and a neighboring lines pitch determining unit 223. The character pitch determining unit 222 is used for, with regard to two characters located at neighboring positions in the same line after being recomposed, setting the pitch of the two characters in accordance with the relationship of the locations of the two characters on the webpage image. The neighboring lines pitch determining unit 223 is used for setting the pitches of the neighboring lines at different pitches according as the neighboring lines having been recomposed locate in the same paragraph or not.

If the two characters locate in the same line and are adjacent to each other on the webpage image, the pitch of the two characters is set at the original pitch by the character pitch determining unit 222. If the two characters locate in different lines on the webpage image, the pitch of the two characters is set at a predetermined pitch by the character pitch determining unit 222.

Furthermore, for two words locate in the same line and are adjacent to each other on the webpage image, if the two words do not locate in the same line after being recomposed, the former word is determined as the last word of a line and the latter word is determined as the first word of a following line by the recomposing unit 220, and the distance between the first word and the last word in the following line is preset as the blank space at the beginning of a line plus the blank space at the end of a line in the same paragraph.

Furthermore, when all of the segmented individual characters are recomposed according to the screen size of the mobile terminal, pitches between neighboring lines are set at different pitches by the neighboring lines pitch determining unit 223 according as the neighboring lines having been recomposed are located in the same paragraph or not. As an example, if the two neighboring lines subjected to recomposing are located in the same paragraph, the pitch of the two neighboring lines is set at one-sixth of the average line-height. If the two neighboring lines subjected to recomposing are not located in the same paragraph, the pitch of the two neighboring lines is set at half of the average line-height.

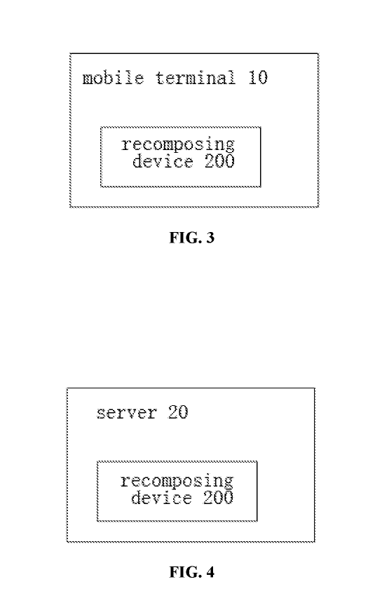

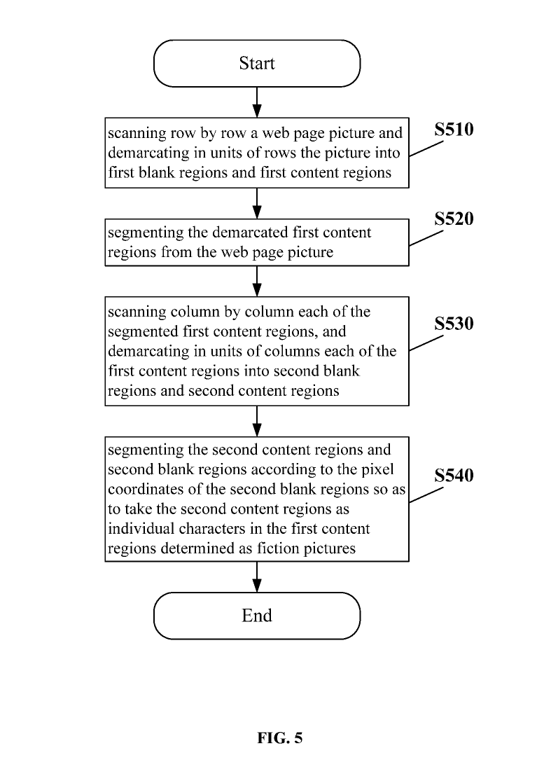

It is noted herein that the device may be installed in the browser of a mobile terminal or at the server-side. FIG. 3 shows the mobile terminal 10 comprising the recomposing device 200 according to the present invention. FIG. 4 shows the server 20 comprising the recomposing device 400 according to the present invention.

The mobile terminals described in the present invention may typically be various terminal devices capable of browsing web pages, such as mobile phones, personal digital assistants and the like. Therefore, the scope of the present invention should not be limited to certain specific mobile terminals.

In addition, the method according to the present invention may also be implemented in CPU-executable computer programs. When executed by the CPU, the computer programs perform the above functions defined in the method according to the present invention.

In addition, the above steps included in the method and system units can be realized by a controller or processor, and by computer-readable storage medium storing computer programs capable of making the controller or processor to implement the above steps or functions of the system units.

In addition, it should be understood that the computer-readable storage medium described herein (e.g., memory) can be volatile memory or nonvolatile memory, or can include both volatile memory and nonvolatile memory. As a non-limiting example, nonvolatile memory may include read-only memory (ROM), programmable ROM (PROM), electrically programmable ROM (EPROM), electrically erasable programmable ROM (EEPROM), or flash memory. Volatile memory may include random access memory (RAM), which may act as external cache memory. As another non-limiting example, the RAM can be obtained in various forms such as synchronous RAM (SRAM), dynamic RAM (DRAM), synchronous DRAM (SDRAM), double data rate SDRAM (DDR SDRAM), enhanced SDRAM (ESDRAM), synchronous link DRAM (SLDRAM), and direct Rambus RAM (DRRAM). It is intended that the disclosed storage medium is including but not limited to these and other suitable types of memory.

Those skilled in the art will understand that, the described various exemplary logic blocks, modules, circuits, and algorithm steps can be implemented in electronic hardware, computer software, or a combination thereof. In order to clearly illustrate this interchangeability between hardware and software, functions of a variety of schematic components, blocks, modules, circuits, and steps are generally described. Whether the functions are implemented in software or hardware depends on the specific application and design constrains applied to the entire system. Those skilled in the art can, for each specific application, use a variety of ways to realize the described functions. However, such specific realization should not be interpreted as departing from the scope of the present invention.

The various exemplary logic blocks, modules, and circuits described here, can be designed as the following components performing the functions described here: general-purpose processor, digital signal processor (DSP), application specific integrated circuits (ASICs), field programmable gate array (FPGA) or other programmable logic device, discrete gate or transistor logic, discrete hardware components, or any combination of these components. The general-purpose processor can be a microprocessor, alternatively, the processor can be any conventional processor, controller, microcontroller or state machine. The processor can also be a combination of computing devices, such as a combination of DSP and microprocessors, multiple microprocessors, one or more microprocessors integrated with a DSP core, or any other such configuration.

The disclosed methods or algorithm steps, in combination of the disclosure herein, may be embodied directly in hardware, software modules executed by the processor, or a combination of both. The software module can reside in RAM memory, flash memory, ROM memory, EPROM memory, EEPROM memory, registers, hard disk, removable disk, the CD-ROM, or any other form of storage medium known in the art. The exemplary storage medium can be coupled to the processor, such that the processor can read information from the storage medium and write information to the storage medium. Alternatively, the storage medium can be integrated with the processor. The processor and the storage medium may reside in an ASIC. The ASIC can reside in the user terminal. Also alternatively, the processor and the storage medium may reside as discrete components in the user terminal.

While the invention has been shown by the above disclosure, it should be noted that various modification and variation can be made therein without departing from the scope of the invention as defined by the appended claims. The functions, steps and/or operations of the method claim in accordance with the embodiments of the invention described here are not necessary to be implemented in specific order. Moreover, although elements mentioned in the present invention can be described or claimed in an individual form, a plurality of elements can be conceived, unless there is a clear limit for singular.

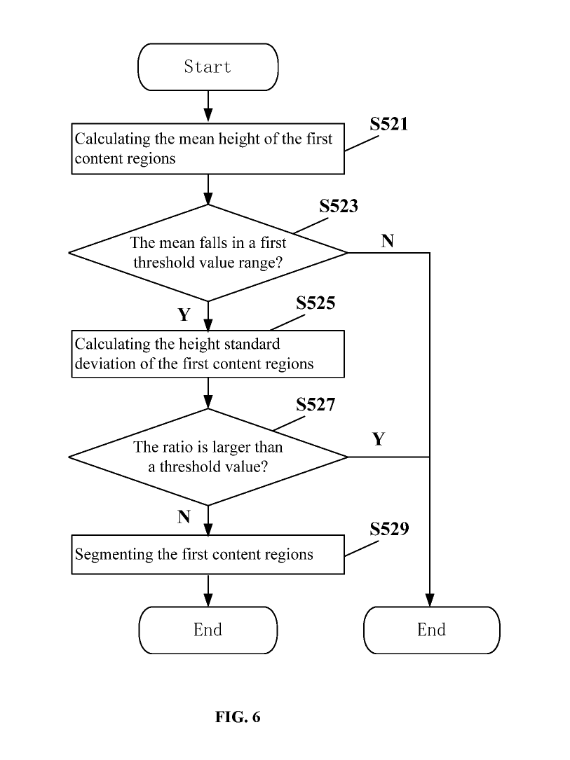

FIG. 5 is a flow chart showing a character segmenting method for web page pictures according to one embodiment of the present invention. The individual characters obtained by the disclosed character segmenting method may be used for recomposing the web pictures as shown in FIG. 1. The web page image may also be referred as web page picture. The novel website may also be referred as fiction website.

As shown in FIG. 5, first, in step S510, the pixels of an web page picture obtained from an objective website (for example, a fiction website) are scanned row by row, and the web page picture is demarcated in units of rows into a plurality of first blank regions each consisting of continuous blank pixel rows and a plurality of first content regions each consisting of continuous content pixel rows, wherein the first blank regions and the first content regions are alternately arranged, for example, a first blank region may consist of one or more continuous blank pixel rows, and a first content region may consist of one or more continuous content pixel rows.

Then, in step S520, the demarcated first content regions are segmented from the obtained web page picture. Specifically, a fiction picture is a web page picture consisting of rows of characters, wherein a blank region is sandwiched between every two adjacent character rows. As for a common fiction picture, the heights of the character rows are usually in a range of 10-30 pixels (i.e. the height characteristic of a character row in a fiction picture), and the mean value of the character rows will fall in the same range. Furthermore, the heights of the character rows in a fiction picture are roughly the same, and the ratio of the standard deviation to the mean thereof is very small (usually less than 1). Thus, preferably, the mean height (and further the ratio of the height standard deviation to the mean height) of the first content regions may be calculated according to the heights of the demarcated first content regions, the first content regions may be determined according to the calculated mean height (or the ratio of the height standard deviation to the mean height) and the height characteristic of the character rows of a fiction picture, and all the first content regions that are determined to be a fiction picture are segmented. The specific process of determining the first content regions and segmenting those that are determined to be a fiction picture will be described with reference to FIG. 6.

FIG. 6 is an exemplified flow chart showing the process of segmenting the first content regions of FIG. 5;

As shown in FIG. 6, first, in step S521, the mean height of the demarcated first content regions is calculated. Then, in step S523, it is determined whether the calculated mean height of the first content regions falls within a first threshold range or not, wherein, the first threshold range, which is also referred to as the height characteristic of the character rows in a fiction picture, may be a range of for example 10 to 30 pixels.

If the calculated mean height of the first content regions doesn't fall within the first threshold range, then it is determined that the first content regions are not a fiction picture, and thus they will not be treated. If the calculated mean height of the first content regions falls within the first threshold range, then proceed to step S525. In step S525, the height standard deviation of the first content regions is further calculated, and then in step S527, it is determined whether the ratio of the height standard deviation to the mean height of the first content regions is less than a second threshold value, which usually is for example 1.

If the ratio is larger than the second threshold value, then it is determined that the first content regions are not a fiction picture, and thus they will not be treated. If the ratio is less than the second threshold value, i.e. it is determined that the first content regions are a fiction picture, then in step S529, the first content regions are segmented with the center lines of two adjacent blank regions thereof as boundaries.

After all the first content regions that are determined to be a fiction figure are segmented from the demarcated first content regions, in step S530, each of the segmented first content regions is scanned column by column, and demarcated in units of columns into a plurality of alternately arranged second blank regions and second content regions, for example, a first content region is segmented into k second content regions and k+1 second blank regions, wherein each of the second blank regions consists of one or more continuous blank pixel columns and each of the second content regions consists of one or more continuous content pixel columns.

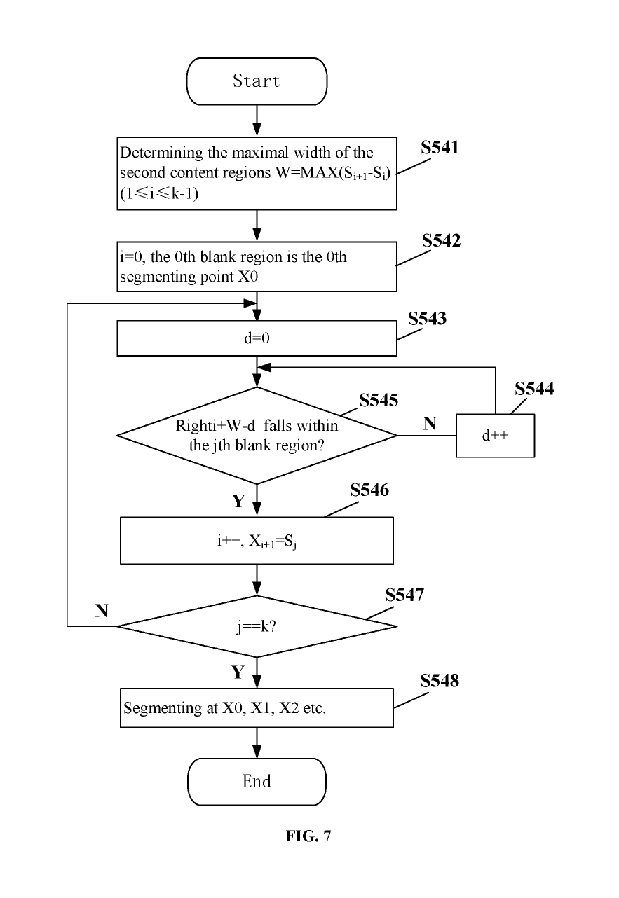

Then, in step S540, the second content regions and the second blank regions are segmented according to the pixel coordinates of the second blank regions, and the segmented second content regions are taken as individual characters in the first content regions that are determined to be a fiction picture. FIG. 7 is an exemplified flow chart showing the process of segmenting the second content regions of FIG. 5.

As shown in FIG. 7, first, in step S541, according to the pixel coordinates of the demarcated second blank regions, for example, the endpoint coordinates or the middle point coordinates of the second blank regions, wherein the middle point coordinate Sᵢ is adopted in this example, i represents the serial number of the second blank regions and ranges from 0 to k, the maximal width W=MAX(Sᵢ₊₁−Sᵢ) of the second content regions is determined, wherein 1≦i≦k−1.

The character segmenting points of the second content regions are determined by using the determined maximal width W of the second content regions and the endpoint coordinates of the second blank regions (i.e. the right endpoint coordinates in this example). A detailed process is shown in step S542 to step S547. In step S542, i is set as i=0, and the middle point X0 of the zeroth blank region is taken as the zeroth character segmenting point. In step S543, the initial value of variable d is set as d=0. In step S545, the sum of the right endpoint coordinate Rightᵢ of the currently segmented blank region and the maximal width W is calculated, and it is determined whether the pixel Rightᵢ+W−d falls within the jth blank region, wherein the coordinates of the right and left endpoints of the jth blank region can be obtained from the mobile terminal. If the pixel Rightᵢ+W−d doesn't fall within the jth blank region, then in step S544, the variable d increases by 1, and return to step S545 to perform circulation. If the pixel Rightᵢ+W−d falls within the jth blank region, then proceed to step S546, and take the middle point of the jth blank region as the right segmenting point of the ith character, i.e. Xᵢ₊₁=Sⱼ, and as the segmenting point of the current character, and i increases by 1. Then, in step S547, it is determined whether j==k or not. If j==k, then proceed to step S548, and in step S548, the second content regions and the second blank regions are segmented by using the determined character segmenting points and the segmented second content regions are taken as individual characters in the first content regions that are determined as fiction pictures; otherwise, return to step S543.

In addition, some websites put watermarks on the pictures, which makes a blank region not fully blank, therefore, when a web page picture is demarcated into blank regions and content regions, some watermark containing blank regions may be determined as content regions, causing that the blank regions cannot be accurately distinguished from the content regions. Thus, preferably, while the pixels of a web page picture obtained from an objective website are scanned row by row or column by column, a watermark filtering treatment may be performed on the web page picture according to the pixel grey values of the scanned web page picture.

Specifically, as for a watermark containing fiction picture, the watermark filtering treatment may be performed by setting a threshold value (for example, a gray scale of 50%), since the gray scale of the watermark is usually relatively low, while that of the characters is relatively high. In this situation, if the gray scale of the pixels of the scanned web page picture is larger than the threshold value, then the pixels may be determined as content pixels, and if the gray scale of the pixels of the scanned web page picture is less than the threshold value, then the pixels may be determined as blank pixels. Herein, the gray scale Gray is the complement of the brightness I, i.e. Gray=1−I. A commonly used calculation formula for brightness may be I=0.299*R+0.587*G+0.114*B.

In addition, in case that a website utilizes a color watermark, the calculation formula for brightness may become I=MAX(R, G, B), and thus that for the gray scale may become Gray=1-MAX(R, G, B), in order to effectively filter the color watermark.

By performing the watermark filtering treatment on the web page picture, the watermark containing blank regions can be prevented from being determined as content regions, thereby the accuracy of distinguishing the blank regions from the content regions and thus the accuracy of character segmenting may be improved.

It should be noted that the above described method may be realized on the browser of a mobile terminal or on a server.

In case the method is realized on the browser of a mobile terminal, the browser usually has a powerful performance. In case the method is realized on a server, the browser of a mobile terminal needs to send the URL of a website to be browsed to the server, and the server obtains web page data from the website, performs character segmenting on it, and sends the segmented characters to the browser of the mobile terminal after finishing the character segmenting.

The character segmenting method for web page pictures according to the present invention has been described with reference to FIG. 5 to FIG. 7. The above character segmenting method for web page pictures according to the present invention may be realized through software or through hardware, or through the combination thereof.

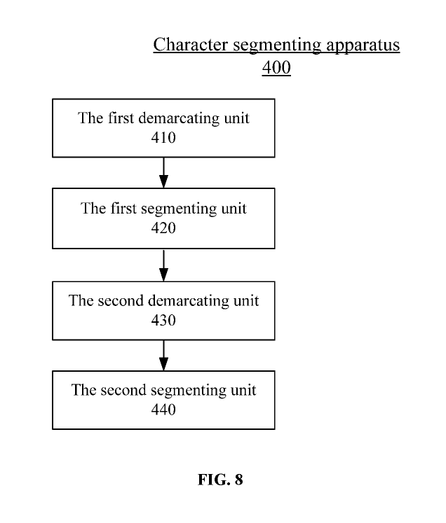

FIG. 8 is a schematic block diagram showing a character segmenting apparatus 400 for web page pictures according to one embodiment of the present invention. As shown in FIG. 8, the character segmenting apparatus 400 comprises a first demarcating unit 410, a first segmenting unit 420, a second demarcating unit 430 and a second segmenting unit 440. The character segmenting apparatus 400 may be the same apparatus as the recomposing device 200 as shown in FIG. 2.

After a web page picture is obtained from an objective website (for example, a fiction website), the first demarcating unit 410 scans row by row the pixels of the obtained web page picture and demarcates in units of rows the web page picture into a plurality of alternately arranged first blank regions each consisting of continuous blank pixel rows and first content regions each consisting of continuous content pixel rows, for example, each of the first blank regions may consist of one or more continuous blank pixel rows, and each of the first content regions may consist of one or more continuous content pixel rows.

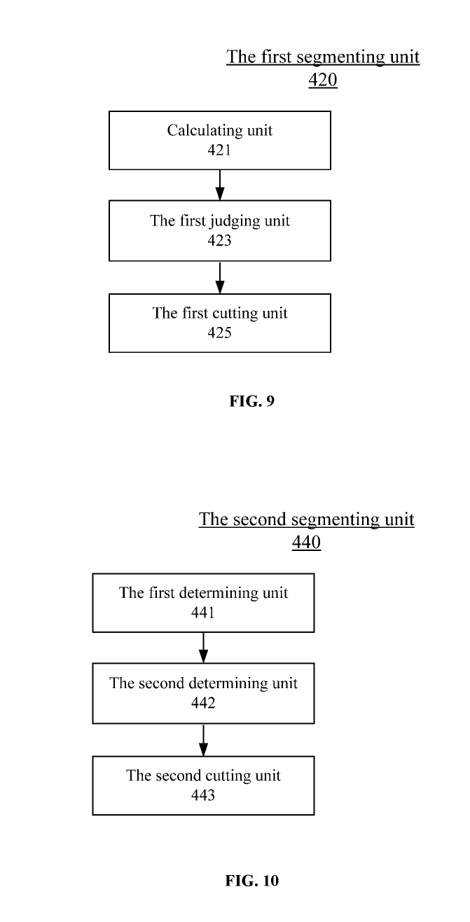

Then, the first segmenting unit 420 segments the demarcated first content regions from the obtained web page picture. Preferably, the first segmenting unit 420 may segment all the first content regions that are determined to be a fiction picture from the obtained web page picture according to the heights of the demarcated first content regions and the height characteristic of the character rows of a fiction picture. The details of the first segmenting unit 420 will be described later with reference to FIG. 9.

After the first content regions determined to be a fiction picture are segmented, the second demarcating unit 430 scans column by column the pixels of each of the segmented first content regions and demarcates in units of columns the first content regions into a plurality of alternately arranged second blank regions each consisting of continuous blank pixel columns and second content regions each consisting of continuous content pixel columns, for example, each of the second blank regions may consist of one or more continuous blank pixel columns, and each of the second content regions may consist of one or more continuous content pixel columns.

After the plurality of second content regions and second blank regions are demarcated, the second segmenting unit 440 segments the second content regions and the second blank regions according to the pixel coordinates of the second blank regions so as to take the segmented second content regions as individual characters in the first content regions determined to be a fiction picture. The details of the second segmenting unit 440 will be described later with reference to FIG. 10.

In addition, preferably, when dealing with watermarks on a web page picture from an objective website, the character segmenting apparatus 400 may further comprise a watermark filtering unit (not shown), while the pixels of an web page picture are scanned row by row or column by column, the water filtering unit is used to perform a watermark filtering treatment on the web page picture according to the pixel grey values of the scanned web page picture.

FIG. 9 is a schematic block diagram showing an exemplified structure of the first segmenting unit 420 of FIG. 8. As shown in FIG. 9, the first segmenting unit 420 may comprise a calculating unit 421, a first judging unit 423 and a first cutting unit 425.

The calculating unit 421 calculates the mean height of the segmented first content regions. When the calculated mean height of the first content regions falls within a first threshold range, the first judging unit 423 determines that the first content regions are a fiction picture. When a first content region is a fiction picture, the first cutting unit 425 cutting the first content region with the center lines of two adjacent blank regions thereof as boundaries.

Furthermore, optionally, the calculating unit 421 may further calculate the height standard deviation of the segmented first content regions, and when the calculated mean height of the first content regions falls within the first threshold range and the ratio of the height standard deviation to the mean height is less than a second threshold value, the first judging unit 423 determines that the first content region is a fiction picture.

Herein, it should be noted that the calculating unit 421 may be put either outside the first judging unit 423, or inside the first judging unit 423.

FIG. 10 is a schematic block diagram showing an exemplified structure of the second segmenting unit of FIG. 8. As shown in FIG. 10, the second segmenting unit 440 may comprise a first determining unit 441, a second determining unit 442 and a second cutting unit 443.

The first determining unit 441 determines the maximal width of the second content regions according to the pixel coordinates of the demarcated second blank regions. The second determining unit 442 determines the character segmenting points of the second content regions by using the determined maximal width of the second content regions and the endpoint coordinates (the right endpoint coordinates in this example) of the second blank regions. After all the character segmenting points are determined, the second cutting unit 443 cutting the second content regions and the second blank regions by using the determined character segmenting points so as to take the segmented second content regions as individual characters in the first content regions that are determined as fiction pictures.

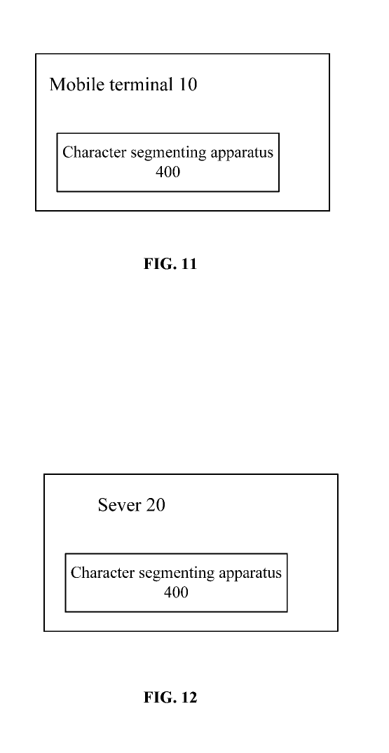

FIG. 11 is a schematic block diagram showing a mobile terminal 10 comprising the character segmenting apparatus 400 according to the present invention. The character segmenting apparatus 400 included in the mobile terminal of FIG. 11 may comprise various modifications of the embodiments of the present invention.

FIG. 12 is a schematic block diagram showing a server 20 comprising the character segmenting apparatus 400 according to the present invention. The character segmenting apparatus 400 included in the server of FIG. 12 may comprise various modifications of the embodiments of the present invention.

Typically, the mobile terminal according to the present invention may be a terminal device that can browse web pages, for example, a mobile phone, a PDA and so on, therefore, the protection scope of the present invention should not be limited to some specific mobile terminals.

In addition, the method according to the present invention may be realized as computer programs executed by CPU. When the computer programs are executed by CPU, the above mentioned functions defined in the method according to the present invention will be realized.

In addition, the above mentioned steps of the method and units of the apparatus may also be realized by using a controller or processor and a computer readable memory device for storing computer programs that can make the controller or processor realize above mentioned steps or unit functions.

Furthermore, it should be noted that the computer readable memory device (for example, a memory) mentioned herein may be a volatile memory or a non-volatile memory, or may comprise both. As an unrestricted example, the non-volatile memory may comprise read-only memory (ROM), programmable read-only memory (PROM), electrically programmable read-only memory (EPROM), electrically erasable programmable read-only memory (EEPROM), or flash memory. The volatile memory may comprise random access memory (RAM), which can act as an external cache memory. As an unrestricted example, RAM may be realized in various ways, for example, synchronous RAM, dynamic RAM (DRAM), synchronous DRAM (SDRAM), double data rate SDRAM (DDR SDRAM), enhanced SDRAM (ESDRAM), synchronous link DRAM (SLDRAM), and direct Rambus RAM (DRRAM). The disclosed memory devices are intended to comprise but not limited to these and other appropriate memories.

It will be apparent for those skilled in the art that various exemplified logic blocks, modules, circuits and algorithm steps described in combination with the disclosure may be realized as electronic hardware, computer software or the combination thereof. In order to clearly illustrate the interchangeability between hardware and software, it has been generally described with respect to the functions of various exemplified assemblies, blocks, modules, circuits and steps. Whether the functions are realized with hardware or software depends on specific applications and the design constraints exerted on the whole system. Those skilled in the art may realize the functions in various ways as far as each specific application is concerned, which, however, should not be construed as departing from the scope of the present invention.

Various exemplified logic blocks, modules, and circuits described in combination with the disclosure may be realized by using the following members configured for performing the herein described functions: universal processor, digital signal processor (DSP), application specific integrated circuit (ASIC), field programmable gate array (FPGA) or other programmable logic devices, discrete gate or transistor logic, discrete hardware modules or the combination of any of the devices. The universal processor may be a microprocessor, but alternatively, the processor may be any traditional processor, controller, micro-controller or state machine. The processor may also be realized as a combination of computing devices, for example, a combination of DSP and microprocessor, multiple microprocessors, one or more DSP combining microprocessor core, or any other similar configurations.

The steps of the method or algorithm described in combination with the disclosure may be directly combined in a hardware unit, or in a software module executed by a processor or in the combination thereof. The software module may be stored in a RAM, a flash memory, a ROM, an EPROM, an EEPROM, a register, a hard disk, a mobile hard disk, a CD-ROM or any other store media known to those skilled in the art. An exemplified store medium is connected to a processor so that the processor may read from or write into the medium. Alternatively, the store medium may be integrated with the processor. The processor and the store medium may be embedded in an ASIC. The ASIC may be embedded in a user terminal. Alternatively, the processor and the store medium may be separately embedded in a user terminal.

Although the exemplified embodiments of the present invention have been shown in the contexts disclosed above, it should be noted that various modifications and variations may be applied thereto without departing from the scope of the invention defined by the claims. The functions, steps and/or actions of the process claims according to herein described embodiments are not necessarily performed in any specific sequence. In addition, although the elements of the present invention may be described or required in a singular form, they may appear in a plural form, unless otherwise stated.

Although the present invention is disclosed in combination of the preferable embodiments showed and described in details, it should be understood by those skilled in the art that, as to the above method and device for recomposing individual characters segmented based on webpage images to be displayed on mobile terminals set forth in the present invention, various improvements can be made without escape the content of the present invention. Accordingly, the scope of protection of the present invention is determined by the contents of the appended claims.

While the present invention has been disclosed with reference to preferred embodiments described in details, those skilled in the art should understand that various modifications may be made to the character segmenting method and apparatus for web page pictures according to the present invention without departing from the contents of the present invention. Therefore, the scope of the present invention should be defined by contents of the appended claims.

What is claimed is:

1. A method for recomposing individual characters, comprising:
obtaining, by a server, individual characters by segmenting contents of a webpage image, including:
scanning row by row the pixels of an obtained web page picture and demarcating in units of rows the web page picture into first blank regions each consisting of continuous blank pixel rows and first content regions each consisting of continuous content pixel rows;
segmenting the demarcated first content regions from the obtained web page picture;
scanning column by column the pixels of each of the segmented first content regions, and demarcating in units of columns each of the first content regions into second blank regions each consisting of continuous blank pixel columns and second content regions each consisting of continuous content pixel columns; and
segmenting the second content regions and the second blank regions according to the pixel coordinates of the second blank regions so as to take the segmented second content regions as individual characters in the first content regions;
when a line of words in a webpage image being processed is determined as a start line of a new paragraph, setting, by the server, the line of words as the start line of the new paragraph being recomposed, and recomposing, by the server, all of the individual characters obtained by segmenting the line of words according to the screen size of the mobile terminal; and
when the line of words is determined as not the start line of a new paragraph, recomposing, by the server, all of the individual characters obtained by segmenting the line of words so as to be immediately after the ending character of the recomposed previous line of words according to the screen size of the mobile terminal.
